(19) United States
(12) Patent Application Publication
(10) Pub. No.: US 2026/0163473 A1
(43) Pub. Date: Jun. 11, 2026

(54) DC-DC CONVERTER AND CONTROL METHOD THEREOF

(71) Applicant: Suzhou Shengbang Microelectronics Co., Ltd., Suzhou (CN)

(72) Inventors: Xiang YU, Suzhou (CN); Jing XU, Suzhou (CN)

(73) Assignee: Suzhou Shengbang Microelectronics Co., Ltd., Suzhou, JS (CN)

(21) Appl. No.: 19/116,679

(22) PCT Filed: Aug. 4, 2023
(86) PCT No.: PCT/CN2023/111185

§ 371 Date: Feb. 27, 2026

(30) Foreign Application Priority Data
Sep. 30, 2022 (CN) 202211211541.X

(51) Int. Cl. H02M 1/36; H02M 1/00; H02M 3/158

(52) U.S. Cl. CPC H02M 1/36; H02M 1/0009; H02M 3/158

(57) ABSTRACT

A DC-DC converter and a control method thereof, the converter includes a logic module, a power tube, an inductor, an output capacitor, a voltage-dividing resistor, an error amplifier, a first control unit, a second control unit and a third control unit; the first control unit realizes the switching of the converter between a constant current start-up mode and a closed-loop start-up mode based on the output voltage, and realizes the delay of the constant current start-up mode based on the output of the second control unit; the second control unit and the third control unit control the switching state of the power tube of the converter in the closed-loop start-up mode based on the magnitude of the inductor current and the output voltage. The method realizes the rapid start-up of the converter and the stability of the output voltage, and ensures the normal start-up of the circuit.

### BACKGROUND

### 1. Technical Field

The present disclosure relates to the field of integrated circuits, and in particular to DC-DC converters and control methods thereof.

### 2. Background Information

DC-DC (Direct Current-Direct Current) converters are widely used in integrated circuits as a voltage converter that can convert input voltage and effectively output a fixed voltage. In DC-DC converters, there are usually two different operating modes: constant current start-up mode and closed-loop start-up mode.

Specifically, when the DC-DC converter just starts, because the circuit output voltage Vout is too small, in order to ensure the start-up speed of the DC-DC converter, the converter usually uses a unique circuit to control the circuit in the constant current conduction state during the start-up process, so that the output voltage increases rapidly. When the output voltage increases to a certain amplitude, in order to prevent the output voltage from continuing to rise and control the stability of the output, the converter will automatically switch to the closed-loop start-up mode, and control the on and off state of the power tube according to the size of the feedback voltage, so as to ensure the relative stability of the output voltage.

However, for this circuit, there may be a problem that the converter oscillates and switches between the constant current conduction state and the closed loop start-up mode and cannot actually start completely. In view of the above problems, a new DC-DC converter and its control method are urgently needed.

### BRIEF SUMMARY

In order to solve the deficiencies in the existing technologies, the object of the present disclosure is to provide a DC-DC converter and a control method thereof, wherein the converter prolongs the time that the circuit is in a constant current start-up mode through a delay unit, and directly jumps to the closed-loop start-up mode after the closed-loop start-up related circuit actually operates normally, thereby achieving rapid start-up of the converter and stable output voltage.

The present disclosure adopts the following technical solution.

A first aspect of the present disclosure relates to a DC-DC converter includes a logic module, a power tube, an inductor, an output capacitor, a voltage divider resistor and an error amplifier, which comprises:
a first control unit, a second control unit and a third control unit; wherein,
the first control unit switching the DC-DC converter between a constant current start-up mode and a closed-loop start-up mode based on an output voltage, and delaying of a constant current start-up mode based on an output of the second control unit;
the second control unit and the third control unit controlling a switching state of a power tube of the DC-DC converter in the closed-loop start-up mode based on a magnitude of an inductor current and the output voltage.

Preferred, the first control unit includes a first comparator and a delay module; wherein, a positive input terminal of the first comparator is an output voltage Vout, a negative input terminal of the first comparator is an input voltage Vin, and an output terminal OUT1 of the first comparator is connected to the delay module;
the delay module receives an output OUT2 of the second control unit, and implements delay based on the control of OUT2, an output OUT3 of the delay module is input into the logic module, and controls the logic module to switch between the constant current start-up mode and the closed-loop start-up mode.

Preferred, when the OUT3 is in a low level state, the DC-DC converter operates in a constant current start-up mode, the power tube Mp0 is long-on, and the power tube Mn0 is long-off;
when the OUT3 is in a high level state, the DC-DC converter operates in a closed-loop start-up mode, and the power tubes Mp0 and Mn0 switch between on and off states based on the outputs of the second control unit and the third control unit.

Preferred, in the DC-DC converter, a device voltage terminal of the error amplifier EA is connected to the output terminal OUT1 of the first comparator in the first control unit; and,
when OUT1 is at a high level, the error amplifier EA enables the second control unit and the third control unit to achieve closed-loop output;
when OUT1 is at a low level, the output of the error amplifier EA is always at a high level, the output of the second control unit OUT2 is always at a high level, and the output of the third control unit is always at a low level.

Preferred, the second control unit includes a current detection module, a voltage control module and a second comparator; wherein,
the current detection module detects an inductor current and outputs a detection result to the voltage control module;
the voltage control module receives the detection result and generates an inverse proportional voltage V1;
a negative phase input terminal of the second comparator receives the inverse proportional voltage V1, a positive phase input terminal of the second comparator receives an output voltage Vea of the error amplifier, and the output terminal of the second comparator generates OUT2 and is connected to the logic module.

Preferred, when the OUT2 is at a high level, the delay module is controlled to implement the delay when the OUT1 signal switches from a low level to a high level;
when the OUT2 is at a low level, the output of the OUT1 signal is not affected.

Preferred, the third control unit includes a third comparator; and,
a negative phase input terminal of the third comparator is connected to the output Vea of the error amplifier, a positive phase input terminal of the third comparator is connected to the detection result output by the current detection module, and the output terminal OUT4 is connected to the logic module.

Preferred, when the DC-DC converter is in the delay process of the delay module,
the converter shields the second control unit and the third control unit based on the control of OUT3, and realizes that the output voltage Vout is equal to the input voltage Vin.

A second aspect of the present disclosure relates to a control method for a DC-DC converter, and the method is implemented by using a DC-DC converter in the first aspect of the present invention.

The beneficial effect of the present disclosure is that, compared with the existing technologies, a DC-DC converter and its control method in the present disclosure can extend the time that the circuit is in the constant current start-up mode through a delay unit, and directly jump to the closed-loop start-up mode after the closed-loop start-up related circuit actually operates normally, thereby realizing the rapid start-up of the converter and the stability of the output voltage, avoiding the converter from switching back and forth between the two working modes, and ensuring the normal start-up of the circuit.

The beneficial effects of the present disclosure also include:
i. the present method does not change the common converter control circuit in the existing technologies, but simply adds a delay module to achieve accurate switching of the working state. In addition, this delay module also cleverly adopts the control of the second control unit to prevent redundant delay logic and ensure the accuracy of the delay logic.
ii. the present disclosure uses a voltage control module to realize the control of the reference voltage V1, so that the reference voltage V1 is actually controlled by the inductor current and changes, so that the control signals OUT2 and OUT3 can change synchronously, thereby ensuring that under any load, it can be smoothly switched from the constant current start-up mode to the closed-loop mode, and ensure the monotonic rise of vout.

### BRIEF DESCRIPTION OF THE DRAWINGS

FIG. 1 is a schematic diagram of the circuit structure of a DC-DC converter in one embodiment of the present disclosure;

FIG. 2 is a voltage timing diagram of each node during the start-up process of a DC-DC converter in one embodiment of the present disclosure;

FIG. 3 is a schematic diagram of the circuit structure of a DC-DC converter in another embodiment of the present disclosure;

FIG. 4 is a voltage timing diagram of each node during the start-up process of a DC-DC converter in another embodiment of the present disclosure.

### DETAILED DESCRIPTION OF THE DRAWINGS AND THE PRESENTLY PREFERRED EMBODIMENTS

The present disclosure is further described below in conjunction with the accompanying drawings. The following embodiments are only used to more clearly illustrate the technical solution of the present disclosure, and cannot be used to limit the protection scope of the present application.

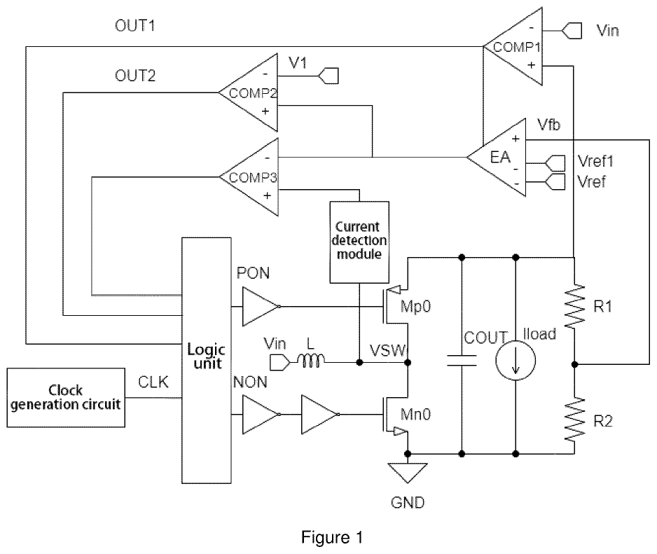

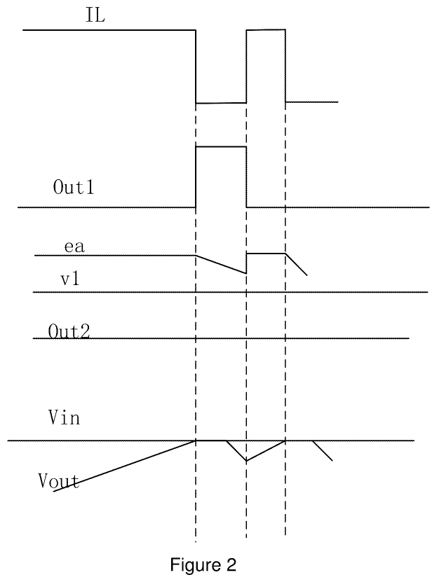

FIG. 1 is a schematic diagram of a circuit structure of a DC-DC converter in one embodiment of the present disclosure. FIG. 2 is a voltage timing diagram of each node during the start-up process of a DC-DC converter in one embodiment of the present disclosure. As shown in FIG. 1 to 2, a DC-DC converter is provided in the present disclosure. Specifically, a DC-DC converter in the existing technologies can usually implement closed-loop start-up control. In addition, in order to increase the initial start-up speed, a constant current start-up circuit can also be included.

However, there are certain problems in this circuit. This problem is illustrated by the circuits in FIG. 1 and FIG. 2 of the present disclosure. In FIG. 1, COMP1, as a first control unit, outputs a control signal OUT1 to a logic module, so that the control circuit is in a constant current start-up mode or a closed-loop start-up mode, respectively. If OUT1 can control the circuit to enter the closed-loop start-up mode, at this time, the error amplifier EA will also realize a variable output Vea under the control of OUT1. At the same time, with the control of the inductor current and the magnitude of the reference voltage V1, the output voltage magnitudes of the control signal OUT2 and COMP3 will change, so that the real-time control logic module outputs the changing PON and NON signals, so that the on or off state of the power tubes Mp0 and Mn0 changes, so that the output voltage can remain relatively stable.

However, as shown in FIG. 2, this circuit may have the following abnormal conditions. When the converter is just started, the output voltage is low. At this time, OUT1 will always be in a low level state. At this time, OUT1 controls the logic module to make Mp0 long-on and Mn0 long-off, so that the inductor current IL remains constant and is output to the output end of the converter at a constant current, so that the output voltage of the converter can keep increasing.

When the output voltage Vout increases to a certain level, for example, increases to be exactly the same as the input voltage Vin, the output level OUT1 of the first comparator COMP1 will be reversed. At this time, OUT1 will control the logic module to no longer be in the constant current start-up mode, but to switch to the closed-loop start-up mode.

In the closed-loop start-up mode, the control signal OUT1 will act as the device voltage of the error amplifier EA and affect the output of the error amplifier EA. Specifically, when the output voltage OUT1 is in a low-level state, the output signal Vea of the error amplifier always remains in a high-level state, and the logic module is actually controlled by OUT1 and also shields the output signals of OUT2 and COMP3. When OUT1 jumps to a high-level state, the output signal of OUT1 causes the MOS tube in the error amplifier EA to be fully turned on, so that the output signal of the error amplifier may be in a high-level and low-level state. At this time, as the reference signal Vref1 gradually increases, when the feedback voltage is approximately equal to R1*Vin/(R1+R2), the output signal Vea of the error amplifier will gradually decrease.

However, if the decreasing speed of Vea is slow, Vea cannot be reduced to less than the reference voltage V1. At this time, the state of the OUT2 signal will not be reversed. The OUT2 signal is always at a high level, which will turn off Mn0 and Mp0 at the same time, making IL=0 A.

Therefore, during this period of time, if a load is connected to the back end of the converter and a certain load current is consumed, the output voltage Vout actually decreases slowly and is lower than Vin. This causes the circuit to reverse the OUT1 signal when the OUT2 signal does not reverse, so that the circuit has not really entered the closed-loop start-up mode, but has returned to the constant current start-up mode, and the output voltage Vout is increased again. In this cycle, the circuit will switch between two different start-up modes many times, and the circuit can never be fully started.

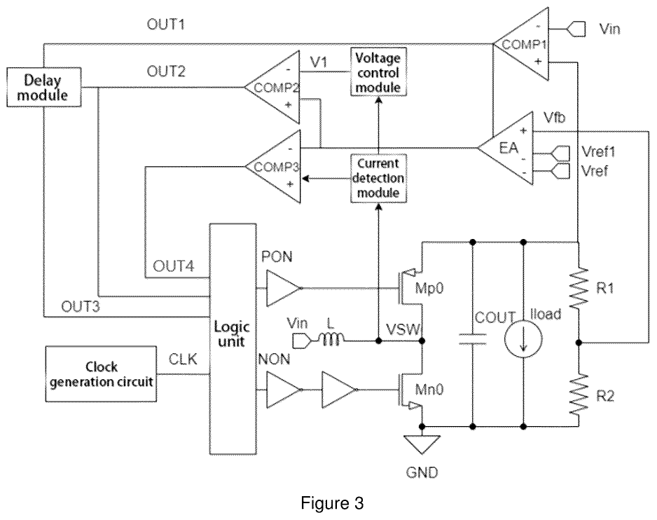

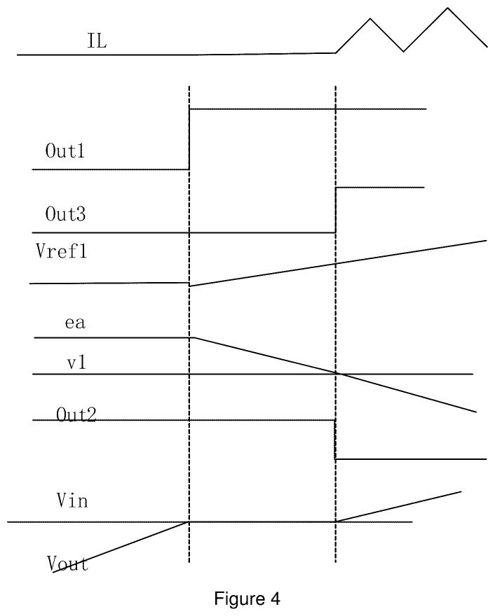

In response to this problem, a new DC-DC converter is provided in the present disclosure. FIG. 3 is a schematic diagram of the circuit structure of a DC-DC converter in another embodiment of the present disclosure. FIG. 4 is a voltage timing diagram of each node during the start-up process of a DC-DC converter in another embodiment of the present disclosure. As shown in FIG. 3 and FIG. 4, a DC-DC converter in the present disclosure includes a logic module, a power tube, an inductor, an output capacitor, a voltage divider resistor and an error amplifier, and the converter also includes a first control unit, a second control unit and a third control unit; wherein the first control unit realizes the switching of the converter between a constant current start-up mode and a closed-loop start-up mode based on the output voltage, and realizes the delay of the constant current start-up mode based on the output of the second control unit; the second control unit and the third control unit control the switching state of the power tube of the converter in the closed-loop start-up mode based on the magnitude of the inductor current and the output voltage.

It can be understood that in the circuit of the present disclosure, a delay module is added to achieve accurate switching between the two start-up modes, thereby reserving a certain time for the actual start-up process of the closed-loop start-up circuit during the process of switching to the closed-loop start-up. When the closed-loop start-up circuit is actually started and truly enters the start-up state, the delay module outputs a control signal to switch the converter to the closed loop, so that the closed-loop signal can control the state of the power tube, thereby achieving a smooth conversion of the start-up mode.

Preferably, the first control unit includes a first comparator and a delay module; wherein, the positive input terminal of the first comparator is the output voltage Vout, the negative input terminal is the input voltage Vin, and the output terminal OUT1 is connected to the delay module; the delay module receives the output OUT2 of the second control unit, and implements delay based on the control of OUT2, the output OUT3 of the delay module is input into the logic module, and controls the logic module to switch between constant current start-up mode and closed-loop start-up mode.

It is understandable that, in the present disclosure, a delay module is added to the first control unit, and the delay module is based on the output voltage of the second control unit OUT2 to achieve actual delay. In other words, when the state of the second control unit changes, the delay module will also be triggered to delay, thereby delaying its switching time from the constant current start mode to the closed-loop start mode state, so that OUT2 and OUT3 can actually enter the closed-loop start mode after the state change has fully occurred.

Preferably, when OUT3 is in a low level state, the converter operates in a constant current start-up mode, the power tube Mp0 is long-on, and the power tube Mn0 is long-off; when OUT3 is in a high level state, the converter operates in a closed-loop start-up mode, and the power tubes Mp0 and Mn0 switch between the on or off state based on the outputs of the second control unit and the third control unit.

It is understandable that after the delay unit, the output signal OUT1 is converted to OUT3, and the high and low states of OUT3 are different, which can be used to control the different start-up modes of the converter. In the present disclosure, when OUT3 is at a low level, the converter is still in the constant current start-up mode. At this time, although OUT1 may have changed to a high level, due to the effect of the delay module, OUT3 has not had time to change. Therefore, during this period, the circuit where COMP2 and COMP3 are located cannot actually control the states of Mp0 and Mn0.

However, after the delay time has passed, the outputs of COMP2 and COMP3 can actually affect the working state of the circuit. At this time, if the signal states of COMP2 and COMP3 happen to change, the delay time is just used to offset the time required before the levels of COMP2 and COMP3 change.

Therefore, the circuit does not switch back and forth between two different start-up modes.

Preferably, in the converter, the device voltage terminal of the error amplifier EA is connected to the output terminal OUT1 of the first comparator in the first control unit; and when OUT1 is at a high level, the error amplifier EA enables the second control unit and the third control unit to achieve closed-loop output; when OUT1 is at a low level, the output of the error amplifier EA is always at a high level, the output of the second control unit OUT2 is always at a high level, and the output of the third control unit is always at a low level.

It is understandable that the device voltage of the error amplifier in the present disclosure is controlled by OUT1, and in this way, the time when the signal of the error amplifier changes is consistent with the time when the delay unit starts the delay. Therefore, the delay time length can also be set more accurately.

Preferably, the second control unit includes a current detection module, a voltage control module and a second comparator; wherein the current detection module detects the inductor current and outputs the detection result to the voltage control module; the voltage control module receives the detection result and generates an inverse proportional voltage V1; the negative phase input terminal of the second comparator receives the inverse proportional voltage V1, the positive phase input terminal receives the output voltage Vea of the error amplifier, and the output terminal generates OUT2 and is connected to the logic module.

It is understandable that the second control unit can perform inverse proportional conversion on the detection result obtained by the current detection module and generate an inverse proportional voltage V1. Specifically, the higher the inductor current, the lower V1.

Conversely, if the inductor current is lower, the higher V1. In this case, if the reference voltage V1 is controlled by the inductor current, the output of OUT2 is actually determined according to the magnitude relationship between the output voltage Vout and the inductor current IL.

Therefore, this comparison actually takes into account that when the power required by the downstream load connected to the converter is different, the level conversion time of OUT2 is also different, so the actual delay time for OUT1 is also different. This method effectively controls the delay time of OUT1 and reasonably controls the output level conversion time of OUT3.

Preferably, when OUT2 is at a high level, the control delay module realizes the delay when the OUT1 signal switches from a low level to a high level; when OUT2 is at a low level, the output of the OUT1 signal is not affected.

It is understandable that when OUT2 is at a high level or a low level, the delay module will exhibit different effects, thereby achieving a reasonable delay.

Preferably, the third control unit includes a third comparator; and the negative phase input terminal of the third comparator is connected to the output Vea of the error amplifier, the positive phase input terminal is connected to the detection result output by the current detection module, and the output terminal OUT4 is connected to the logic module.

The specific logic of the control logic unit by the output signal OUT4 of the third control unit can be implemented by referring to the contents in the existing technologies, which will not be elaborated in the present disclosure.

When the converter is in the delay process of the delay module, the converter shields the second control unit and the third control unit. As shown in FIG. 4, at this time, Vout will not decrease, but always remain at the input voltage Vin. After the second and third control units switch the working state, the actual switching control is realized, thereby fully preventing the back and forth switching of the two start-up states, so that the circuit accurately enters the closed-loop start-up mode.

A second aspect of the present disclosure relates to a control method for a DC-DC converter, which is implemented by using a DC-DC converter in the first aspect of the present disclosure.

Although the present application is described in conjunction with specific features and embodiments thereof, it is obvious that various modifications and combinations may be made thereto without departing from the spirit and scope of the present application. Accordingly, the present specification and drawings are merely exemplary illustrations of the present application as defined by the appended claims, and are deemed to have covered any and all modifications, variations, combinations or equivalents within the scope of the present application. Obviously, a person skilled in the art may make various modifications and variations to the present application without departing from the spirit and scope of the present application. Thus, if these modifications and variations of the present application fall within the scope of the claims of the present application and their equivalents, the present application is also intended to include these modifications and variations.

The beneficial effect of the present disclosure is that, compared with the existing technologies, a DC-DC converter and a control method thereof in the present disclosure can extend the time that the circuit is in a constant current start-up mode through a delay unit, and directly jump to a closed-loop start-up mode after the closed-loop start-up related circuit actually operates normally, thereby realizing a fast start-up of the converter and a stable output voltage, avoiding the converter from switching back and forth between the two working modes, and ensuring the normal start-up of the circuit.

The applicant of the present disclosure has made a detailed explanation and description of the implementation examples of the present disclosure in conjunction with the drawings in the specification. However, those skilled in the art should understand that the above implementation examples are only preferred implementation schemes of the present disclosure, and the detailed description is only to help readers better understand the spirit of the present disclosure, but not to limit the scope of protection of the present disclosure. On the contrary, any improvements or modifications based on the inventive spirit of the present disclosure should fall within the scope of protection of the present disclosure.

1. A DC-DC converter includes a logic module, a power tube, an inductor, an output capacitor, a voltage divider resistor and an error amplifier, further comprising:
a first control unit, a second control unit and a third control unit; wherein,
the first control unit switching the DC-DC converter between a constant current start-up mode and a closed-loop start-up mode based on an output voltage, and delaying of a constant current start-up mode based on an output of the second control unit;
the second control unit and the third control unit controlling a switching state of a power tube of the DC-DC converter in the closed-loop start-up mode based on a magnitude of an inductor current and the output voltage.

2. The DC-DC converter in claim 1, further comprising:
the first control unit includes a first comparator and a delay module; wherein, a positive input terminal of the first comparator is an output voltage Vout, a negative input terminal of the first comparator is an input voltage Vin, and an output terminal OUT1 of the first comparator is connected to the delay module;
the delay module receives an output OUT2 of the second control unit, and implements delay based on the control of OUT2, an output OUT3 of the delay module is input into the logic module, and controls the logic module to switch between the constant current start-up mode and the closed-loop start-up mode.

3. The DC-DC converter in claim 2, further comprising:
when the OUT3 is in a low level state, the DC-DC converter operates in a constant current start-up mode, the power tube Mp0 is long-on, and the power tube Mn0 is long-off;
when the OUT3 is in a high level state, the DC-DC converter operates in a closed-loop start-up mode, and the power tubes Mp0 and Mn0 switch between on and off states based on the outputs of the second control unit and the third control unit.

4. The DC-DC converter in claim 3, further comprising:
in the DC-DC converter, a device voltage terminal of the error amplifier EA is connected to the output terminal OUT1 of the first comparator in the first control unit; and,
when OUT1 is at a high level, the error amplifier EA enables the second control unit and the third control unit to achieve closed-loop output;
when OUT1 is at a low level, the output of the error amplifier EA is always at a high level, the output of the second control unit OUT2 is always at a high level, and the output of the third control unit is always at a low level.

5. The DC-DC converter in claim 4, further comprising:
the second control unit includes a current detection module, a voltage control module and a second comparator; wherein,
the current detection module detects an inductor current and outputs a detection result to the voltage control module;
the voltage control module receives the detection result and generates an inverse proportional voltage V1;
a negative phase input terminal of the second comparator receives the inverse proportional voltage V1, a positive phase input terminal of the second comparator receives an output voltage Vea of the error amplifier, and the output terminal of the second comparator generates OUT2 and is connected to the logic module.

6. The DC-DC converter in claim 5, further comprising:
when the OUT2 is at a high level, the delay module is controlled to implement the delay
when the OUT1 signal switches from a low level to a high level;
when the OUT2 is at a low level, the output of the OUT1 signal is not affected.

7. The DC-DC converter in claim 6, further comprising:
the third control unit includes a third comparator; and,
a negative phase input terminal of the third comparator is connected to the output Vea of the error amplifier, a positive phase input terminal of the third comparator is connected to the detection result output by the current detection module, and the output terminal OUT4 of the third comparator is connected to the logic module.

8. The DC-DC converter in claim 7, further comprising:
when the DC-DC converter is in the delay process of the delay module,
the converter shields the second control unit and the third control unit based on the control of OUT3, and realizes that the output voltage Vout is equal to the input voltage Vin.

9. A control method for a DC-DC converter, further comprising:
the method is implemented by using a DC-DC converter as described in claim 1.
